(19) United States
(12) Patent Application Publication
(10) Pub. No.: US 2002/0170381 A1
(43) Pub. Date: Nov. 21, 2002

(54) Articulated fitting for a vehicle seat

(75) Inventors: Richard Hansel, Flonheim (DE); Andreas Ruth, Kaiserslautern (DE); Karl Utzinger, Weselberg (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: KEIPER GmbH & Co

(21) Appl. No.: 10/151,541

(22) Filed: May 20, 2002

(30) Foreign Application Priority Data
May 21, 2001 (DE) 101 24 618.8

(51) Int. Cl. G05G 1/00

(52) U.S. Cl. 74/577 M

(57) ABSTRACT

In an articulated fitting (5) for a vehicle seat, particularly for a motor vehicle seat, consisting of a first fitting part (7), a second fitting part (8) pivotable relative to the first fitting part (7) around an axis of rotation (10), a detent pawl (15) for locking the second fitting part (8), which is pivotably mounted on the first fitting part (7), and a clamping element (25) mounted in a pivotable manner for securing the detent pawl (15) in a locked state, the clamping element (25), through a pivotably mounted cam (31), acts on a detent pawl (15), the cam (31) being mobile relative to the detent pawl (15).

### BACKGROUND OF THE INVENTION

The present invention relates to an articulated fitting for a vehicle seat, in particular for a motor vehicle seat.

In a known articulated fitting for a vehicle seat, a clamping element abuts the side of a detent pawl that is opposite from the teeth of the detent pawl. The clamping element provides a closing moment on the detent pawl by virtue of a spring load. Depending on the tolerances, there can be a play in the bearing of the detent pawl. Translated by the ratio between the length of the backrest and the dimension of the detent pawl, this play, even in a locked position, may allow relatively large movements of the backrest, which are undesirable with respect to a functionally secure interaction, wear and tear of the components of the articulated fitting, and sitting comfort.

### BRIEF SUMMARY OF THE INVENTION

One aspect of the present invention is the provision of at least one improvement to the known articulated fitting mentioned above. In accordance with this aspect, the articulated fitting includes a first fitting part, a second fitting part mounted for rotating about an axis of rotation relative to the first fitting part, and a detent pawl pivotably mounted on the first fitting part for moving into a locking position in which the detent pawl locks the second fitting part to restrict rotation of the second fitting part. In accordance with this aspect, the articulated fitting further includes a cam pivotably mounted for moving relative to the detent pawl, and a clamping element that is pivotably mounted for forcing the cam to move so that the cam forces the detent pawl into the locking position. That is, in accordance with this aspect, the clamping element acts on the detent pawl via the cam.

By virtue of the fact that the clamping element acts on the detent pawl through the pivotably mounted cam, with the cam being movable relative to the detent pawl, the cam and the detent pawl can be moved against each other in such a manner that the play of the detent pawl is eliminated, or at least reduced. It is preferable that the geometrical relations are chosen in such a way that a force component of the clamping element acting on the cam tensions the detent pawl and the cam relative to each other and also the detent pawl relative to its bearing. A controlled, limited relative movement can preferably be obtained by a slot and pin guidance. The desired geometrical conditions are preferably obtained by an appropriate arrangement of a clamping curve (i.e., a curved surface), which is acted upon by a cam. The clamping curve is preferably curved eccentrically with respect to the bearing of the detent pawl, with the center of the clamping curve being located toward the axis of rotation of the fitting parts, so that it provides not only a locking moment on the detent pawl, but also a play-reducing force component.

In accordance with one aspect of the present invention, an articulated fitting according to the present invention can be used for all vehicle seats where the backrest possesses an inclination setting function, folding function, swing-free function or combination thereof. In accordance with one aspect of the present invention, an articulated fitting according to the present invention can also be used for other pivotable components of a vehicle seat.

### BRIEF DESCRIPTION OF THE DRAWINGS

Having thus described the invention in general terms, reference will now be made to the accompanying drawings, and the invention is explained in greater detail below with reference to an exemplary embodiment which is illustrated in the drawings, in which:

FIG. 1 is a partial view of an articulated fitting of the exemplary embodiment,

FIG. 2 is a schematic lateral view of a vehicle seat incorporating the articulated fitting of the exemplary embodiment, and

FIG. 3 is a vertical section through the exemplary embodiment in the area of the detent pawl.

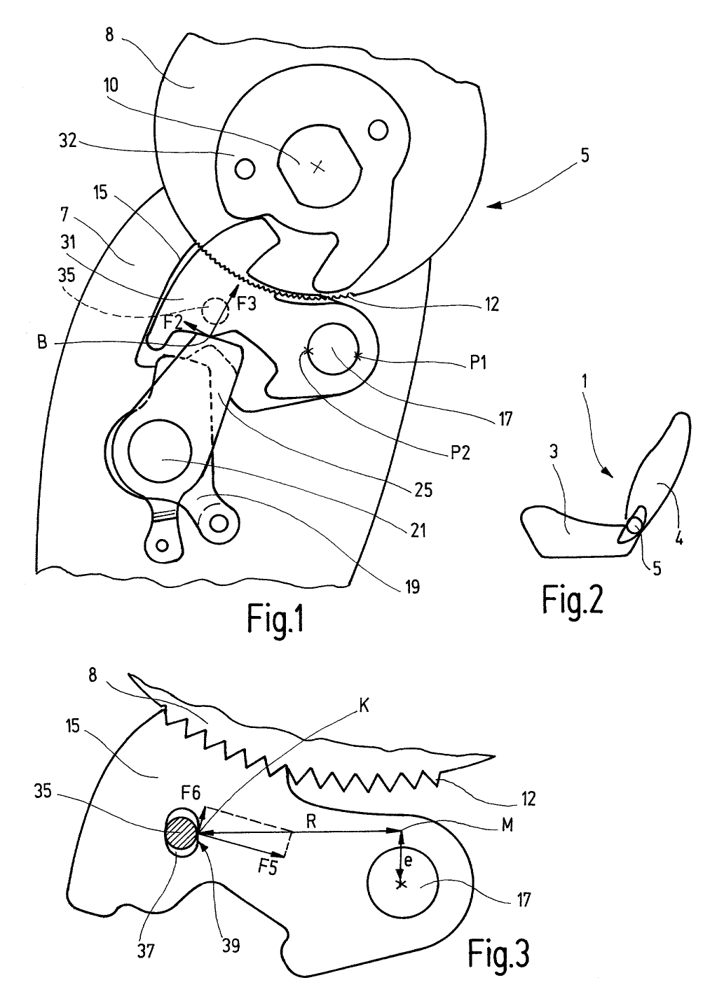

### DETAILED DESCRIPTION OF THE INVENTION

The present invention now will be described more fully hereinafter with reference to the accompanying drawings, in which one, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

A vehicle seat 1 for a motor vehicle is equipped with a seat component 3 and a backrest 4, which is pivotably connected with the seat component 3 on both sides of the vehicle seat, with each connection being by means of an articulated fitting 5. Each articulated fitting 5 has a lower fitting part 7 for being fixed to the seat component 3, and an upper fitting part 8 for being fixed to the backrest 4. The upper fitting part can be pivoted relative to the lower fitting part 7 around a backrest bolt 10 defining a rotation axis.

The upper fitting part 8, over a certain angle area, bears a curved, toothed ring 12 as an external toothing whose center coincides with the backrest bolt 10. This external toothing is below the backrest bolt 10 while the backrest 4 is in its upright position. In a locked position of the articulated fitting 5, a detent pawl 15, which is pivotably mounted on a pivot that is in the form of a pawl bolt 17 of the lower fitting part 7, meshes with the toothed ring 12, thus locking the articulated fitting 5. In the event of a crash, the spring-loaded detent pawl 15 is secured, in a way that is known, by an intercepting element 19. The intercepting element 19 is spring-loaded and mounted in a pivotable manner on a bearing bolt 21 of the lower fitting part 7. The intercepting element 19 is arranged at the side of the pawl 15 that is opposite from the toothed ring 12, and the intercepting element 19 is arranged in the immediate proximity of an intercepting surface of the detent pawl 15.

In addition, a clamping element 25 is mounted on the bearing bolt 21. The clamping element 25 is spring-loaded and, with its end bent eccentrically relative to the bearing bolt 21, bears against the clamping surface of a control cam 31. The control cam 31, which is pivotably mounted on the pawl bolt 17, interacts, on the one hand, with a control plate 32 fixed to the upper fitting part. The control plate 32 is arranged around the backrest bolt 10. The control cam 31, on the other hand, through a protruding protrusion or tongue 35 which, similar to a slot and pin guidance, latches into an elongated hole 37 in the detent pawl, acts on a clamping curve 39. The clamping curve 39 is formed by a part of the edge of the elongated hole 37. The meshing of the detent pawl 15 into the toothed ring 12 is secured by the force thus transmitted from the control cam 31. At the same time, through a relative movement between the control cam 31 and the detent pawl 15, these two components are clamped at the bearing, i.e. at the pawl bolt 17, in such a manner that the play is eliminated, or at least reduced.

The forces and moments responsible for the reduction of the bearing play are described below. The spring force bearing on the lower end of the clamping element 25 is translated, by virtue of the small eccentricity, into a correspondingly large force in the point of contact B between the clamping element 25 and the control cam 31. This force, with respect to the backrest bolt 10, has a tangential component F2 and a radial component F3. The radial component F3, by means of a lever corresponding to the distance to the pawl bolt 17, acts as a moment on the control cam 31 and generates a force in the point of contact K between the tongue 35 and the clamping curve 39.

The clamping curve 39 has a radius R (i.e., R is the radius of curvature of the clamping curve 39) and an eccentricity e, i.e. a distance e between the center M of the clamping curve 39 and the pawl bolt 17. The center M, which is the center of curvature of the clamping curve 39, is approximately on the straight line between the pawl bolt 17 and the backrest bolt 10. The force acting at the point of contact K, which is directed to the center M of the clamping curve 39, can be broken up, with respect to the pawl bolt 17, into a radial component F5 and a circumferential component F6. The circumferential component F6 applies a locking moment on the detent pawl 15. The radial component F5 and a lever, which is defined by the distance between the point of contact K and the backrest bolt 10, builds up a moment, which can compensate for a moment bearing on the upper fitting part 8, i.e. which reduces the bearing play at the pawl bolt 17. The control cam 31, by virtue of a radial component F5, bears against the pawl bolt 17 at point P1 which is relatively far away from the elongated hole, whereas the detent pawl 15, clamped for this purpose, bears against the pawl bolt 17 at point P2 which is relatively close to the elongated hole.

In order to unlock the articulated fitting 5, the intercepting element 19 is pivoted, for example through action of a cable, in such a manner that it detaches itself from the detent pawl 15. Then, the interceptive element 19 first takes with it the clamping element 25, which detaches itself from the control cam 31. Thereafter and as a result, the detent pawl 15 disengages from the toothed ring 12. The upper fitting part 8 and, with it, the backrest 4, can now be pivoted into the desired position relative to the lower fitting part 7 and thus relative to the seat component 3. When releasing the intercepting element 19, the various spring loads ensure a return into the locked state.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An articulated fitting for a vehicle seat, the articulated fitting comprising:
a first fitting part;
a second fitting part mounted for rotating about an axis of rotation relative to the first fitting part;
a detent pawl pivotably mounted on the first fitting part for moving into a locking position in which the detent pawl locks the second fitting part to restrict rotation of the second fitting part;
a cam pivotably mounted for moving relative to the detent pawl; and
a clamping element pivotably mounted for forcing the cam to move so that the cam forces the detent pawl into the locking position,
whereby the clamping element acts on the detent pawl via the cam.

2. An articulated fitting according to claim 1, wherein one of the cam and the detent pawl includes a slot, and the other of the cam and the detent pawl includes a protrusion that extends into the slot, and the protrusion and the slot are operative, in response to the clamping element forcing the cam to move, to cause:
the detent pawl to move into the locking position, and
the cam to move, to at least a limited extent, relative to the detent pawl.

3. An articulated fitting according to claim 1, wherein one of the cam and the detent pawl includes a curved surface that is positioned so that engagement between the cam and the detent pawl occurs at the curved surface while the cam forces the detent pawl into the locking position, and said engagement causes the detent pawl to move into the locking position.

4. An articulated fitting according to claim 3, wherein the curved surface at least partially defines an elongated hole in the detent pawl.

5. An articulated fitting according to claim 3, wherein the curved surface has a radius of curvature that is defined between the curved surface and a center of curvature of the curved surface, the detent pawl is pivotably mounted on the first fitting part by a pivot, and the center of curvature of the curved surface is spaced apart from the pivot.

6. An articulated fitting according to claim 5, wherein the center of curvature of the curved surface is at least approximately arranged between the pivot and the axis of rotation about which the second fitting part is rotatable relative to the first fitting part.

7. An articulated fitting according to claim 5, wherein the cam is pivotably mounted on the pivot, and said engagement at the curved surface causes relative movement between the cam and the detent pawl, so that the cam and the detent pawl function together to clamp onto the pivot in a manner that reduces play within the articulated fitting.

8. An articulated fitting according to claim 7, wherein said relative movement between the cam and the detent pawl, which causes the cam and the detent pawl to function together to clamp onto the pivot, causes the cam and the detent pawl to be forced against different and spaced apart points on the pivot.

9. An articulated fitting according to claim 1, further comprising a control element that is fixed to the upper fitting part, wherein the cam interacts with the control element.

10. An articulated fitting according to claim 1, wherein the articulated fitting is in combination with the vehicle seat, and wherein the vehicle seat includes a first seat part that is mounted to the first fitting part, and a second seat part that is mounted to the second fitting part.

11. An articulated fitting according to claim 4, wherein the cam includes a protrusion that extends into the hole, and the protrusion and the hole are operative, in response to the clamping element forcing the cam to move, to cause:
the detent pawl to move into the locking position, and the cam to move, to at least a limited extent, relative to the detent pawl.

12. An articulated fitting according to claim 4, wherein the curved surface has a radius of curvature that is defined between the curved surface and a center of curvature of the curved surface, the detent pawl is pivotably mounted on the first fitting part by a pivot, and the center of curvature of the curved surface is spaced apart from the pivot.

13. An articulated fitting according to claim 6, wherein the cam is pivotably mounted on the pivot, and said engagement at the curved surface further causes relative movement between the cam and the detent pawl, so that the cam and the detent pawl function together to clamp onto opposite portions of the pivot in a manner that reduces play within the articulated fitting.

14. An articulated fitting according to claim 7, further comprising a control element that is fixed to the upper fitting part, wherein the cam interacts with the control element.

15. An articulated fitting according to claim 13, further comprising a control element that is fixed to the upper fitting part, wherein the cam interacts with the control element.

16. An articulated fitting according to claim 7, wherein the articulated fitting is in combination with the vehicle seat, and wherein the vehicle seat includes a first seat part that is mounted to the first fitting part, and a second seat part that is mounted to the second fitting part.

17. An articulated fitting for a vehicle seat, the articulated fitting comprising:
a first fitting part;
a second fitting part mounted for rotating about an axis of rotation relative to the first fitting part, with the second fitting part including a pivot;
a detent pawl pivotably mounted on the pivot for moving into a locking position in which the detent pawl locks the second fitting part to restrict rotation of the second fitting part;
a cam pivotably mounted on the pivot; and
a clamping element pivotably mounted for forcing the cam to move and thereby interact with the detent pawl,
wherein the cam and the detect pawl are counstructed so that the interaction between the cam and the detent pawl causes:
the detent pawl to move into the locking position, and
relative movement between the cam and the detent pawl so that the cam and the detent pawl are respectively forced in substantially opposite directions against different points on the pivot and thereby function together to clamp onto the pivot in a manner that reduces play within the articulated fitting.

18. An articulated fitting according to claim 17, wherein one of the cam and the detent pawl includes a surface, and the interaction between the cam and the detent pawl includes engagement between the cam and the detent pawl at the surface, and wherein the surface at least partially defines a hole in one of the cam and the detent pawl, the other of the cam and the detent pawl includes a protrusion that extends into the hole, and the protrusion and the hole are operative for providing the interaction between the cam and the detent pawl.

19. An articulated fitting according to claim 17, further comprising a control element that is fixed to the upper fitting part, wherein the cam interacts with the control element.

20. An articulated fitting according to claim 17, wherein one of the cam and the detent pawl includes a curved surface that has a radius of curvature that is defined between the curved surface and a center of curvature of the curved surface, the interaction between the cam and the detent pawl includes engagement between the cam and the detent pawl at the curved surface, the center of curvature of the curved surface is spaced apart from the pivot, and the center of curvature of the curved surface is at least approximately arranged between the pivot and the axis of rotation about which the second fitting part is rotatable relative to the first fitting part.
